(19) United States
(12) Patent Application Publication
(10) Pub. No.: US 2004/0247506 A1
(43) Pub. Date: Dec. 9, 2004

(54) Process for stabilizing emissions from high-temperature industrial processes

(76) Inventors: Ajit K. Chowdhury, Madison, WI (US); Lane D. Tickanen, Iron River, MI (US); Michael Warner, Waunakee, WI (US)

Correspondence Address: Bennett J. Berson, Quarles & Brady LLP, P.O. Box 2113, Madison, WI, 53701-2113, US

(21) Appl. No.: 10/456,255

(22) Filed: Jun. 6, 2003

(51) Int. Cl. B01D 53/40

(52) U.S. Cl. 423/220

(57) ABSTRACT

A method for treating a flue emissions stream from a high-temperature industrial process in which the stream comprises an acid gas and particulates contaminated with a hazardous metal includes the steps of dry injecting into the stream a metal stabilizing agent in an amount sufficient to reduce leaching potential of the metal under natural or induced leaching conditions and an acid gas treating agent that comprises a reactive alkaline oxide powder (−400 mesh or smaller) having a surface area of at least about 35 m²/g, (when measured by BET) in an amount sufficient to remove at least 40% of the acid gas and to act as a pH control agent for the metal stabilizing aspect of the invention.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

Emissions from high-temperature industrial operations (i.e., foundries, smelters, municipal and solid waste or medical waste incinerators, etc.) are regulated in that hazardous air pollutants (HAPs) in such emissions must meet certain industry-specific MACT (Maximum Achievable Control Technology) standards. Specifically, melting operations that generate air emissions having certain Toxicity Characteristic Leaching Procedure (TCLP) toxic particulate matter and acid gases (HCl, HF, and SOₓ) must stabilize the TCLP-toxic particulates and substantially remove the acid gases before the air emissions are released into the atmosphere.

Common strategies for the treating wastes containing heavy metal contaminants can be placed in one of two categories. 1) chemical stabilization or fixation, which includes treating the residue with a chemical additive so that the contaminant is converted to a low solubility form, and 2) solidification, which includes adding a binder, cement or pozzolan and lime to the residue to produce a low permeability matrix that retards or reduces the rate of contaminant migration into the surrounding environment. A third, less common, method includes washing contaminated waste to dissolve the metal contaminants in the waste, and recapturing the metals from solution in subsequent precipitation or filtering steps.

Processes for stabilizing heavy metals in incineration/melting operation emissions are also known in the prior art: Cement and calcium sulfoaluminate injection into duct work (U.S. Pat. No. 4,878,944); Addition of stabilization agents, including phosphates, into the waste prior to its processing in waste treatment equipment (U.S. Pat. No. 6,050,929); Addition of yellow phosphorus/phosphorous oxides into the combustion zone (U.S. Pat. No. 5,284,636)

Many combustion or incineration processes release acid gas which must be neutralized prior to release into the atmosphere to comply with air pollution emission regulations. Systems for injecting alkali into the gas stream are well known in the art. The principal product used for acid gas control is quicklime or hydrated lime injected into the combustion gas stream. To achieve satisfactory efficiencies, excess lime (greater than stoichiometric acid requirements) is typically added during this process. The excess lime is then captured in baghouses or fabric filters and subsequently combined with the incineration residues or ash. In some processes excess lime is used as an alkaline reagent to chemically stabilize the combustion residues.

In systems that employ a spray dryer absorber and bag filter or electrostatic precipitator systems, the flue gas is contacted with a fine spray of an aqueous solution or slurry of a reactive alkali, with the acid gas removal and drying occurring simultaneously. The acid gas is absorbed into the water droplet during the constant rate period of drying until it shrinks to the extent that the particles touch each other. During the following falling rate period, the remaining water diffuses through the pores of agglomerated particles until the solids establish pseudo-equilibrium with the humid environment of the spray dryer.

The third drying stage can be called the second falling rate period. Any drying/mass transfer during this period is limited by the diffusion of moisture from within tightly packed particles. The first two stages take place exclusively in the spray dryer. The majority of pseudo-equilibrium period occurs in the duct joining the spray dryer and the bag filter, and in the bag filter itself.

Simultaneous treatment for the removal of acid gases and the stabilization of heavy metals from incineration/ melting operation emissions is disclosed in the following patents: Wet scrubbing of incinerator emissions with lime followed by calcination in the presence of oxygen at 375-800° C. (U.S. Pat. No. 5,220,111); Treatment with sulfonated calcium aluminum magnesium phosphate plus magnesium sulfite/hydroboracite (U.S. Pat. No. 5,719,099); Treatment with magnesium sulfite along with triple superphosphate, limestone, and hydroboracite (U.S. Pat. No. 6,191,068); Removal of mercury, dioxins and furans, acid gases, and nitrogen oxides (NOₓ) by injecting powdered activated carbon and alkali (including lime, sodium carbonate, and limestone) slurry along with the flue gases in a spray dryer (U.S. Pat. No. 4,889,698); Removal of mercury, cadmium, and thallium and acid gases by injection of dry sodium bicarbonate along with activated carbon (U.S. Pat. Nos. 5,695,726; 5,569,435); Use of phosphate, along with sodium carbonate, for lead immobilization and acid gas control (U.S. Pat. No. 5,545,805)

As disclosed in prior art, the quick lime-based chemistries for acid gas scrubbing require slurry injection, wet scrubbing, or high temperature dry operation and may not be effectively combined with proven metals stabilization chemistries because of adverse pH vs. solubility relationship, and therefore leachability, of certain heavy metals (such as lead) present in the emission particulates.

Sodium bicarbonate is known to be effective for acid gas scrubbing only at temperatures of approximately 350° F., above which substantial decomposition of bicarbonate to carbonate occurs. The carbonate thus formed neutralizes the acid gases. Acid gas removal by direct addition of sodium carbonate is ineffective. (K. T. Fellows, et al. “HCI Sorption by Dry NaHCO₃ for Incinerator Emissions Control.” JAWMA 40(6) 887-893. June 1990; T. C. Keener, et al. “Study of the Reaction of SO₂ with NaHCO₃ and Na2CO₃.” JAPCA 34(6), 651-654. June 1984; Trona Use in Dry Sodium Injection for Acid Gas Removal. Solvay Minerals Technical Publication, 2001. P. Marier and H. P. Dibbs. “The Catalytic Conversion of SO₂ to SO₃ by Fly Ash and the Capture of SO₂ and SO₃ by CaO and MgO.” Thermochimica Acta § (1974) 155-165

Magnesium-based chemistries for acid gas scrubbing in prior art processes use magnesium hydroxide slurry scrubbing. Marier and Dibbs report dry scrubbing of SO₂ by MgO to be effective at high temperatures (800° C.) and upon conversion of SO₂ to SO₃. (P. Marier and H. P. Dibbs. “The Catalytic Conversion of SO₂ to SO₃ by Fly Ash and the Capture of SO₂ and SO₃ by CaO and MgO.” Thermochimica Acta § (1974) 155-165)

Prior art processes for simultaneous acid gas removal and hazardous particulate stabilization are cumbersome and involve high-maintenance operations, e.g., requiring slurry injection or wet scrubbing for acid gas removal. In addition, such processes operate at relatively higher temperatures requiring expensive baghouse dust collection systems and use complicated and expensive additive chemistries.

It would be desirable in the art to develop processes for simultaneous acid gas removal and metal stabilization that overcome the disadvantages of the prior art.

### BRIEF SUMMARY OF THE INVENTION

The present invention is summarized in that a method for treating a flue emissions stream from a high-temperature industrial process in which the stream comprises an acid gas and particulates contaminated with a hazardous metal includes the steps of dry injecting into the stream a metal stabilizing agent in an amount sufficient to reduce leaching potential of the metal under natural or induced leaching conditions and an acid gas treating agent that comprises a reactive alkaline earth metal oxide powder having a surface area of at least about 35 m²/g, (when measured by BET) in an amount sufficient to remove acid gas, preferably at least about 40% of the acid gas, and to act as a pH control agent for the metal stabilizing aspect of the invention. A suitable powder can, but need not, comprise particles of −400 mesh. A sufficient amount of the alkaline oxide powder can be at least one order of magnitude more than the stoichiometric amount required to neutralize the acid gas, the excess acting as a pH control agent. The high surface area of oxide powder facilitates reaction of the acid gases in the short available reaction time.

The invention finds particular utility in treating emissions from a process that generates particulates containing hazardous metals, such as a scrap melting process in a foundry. The invention is practiced upstream of the point at which particulates are collected (e.g., a foundry baghouse). The metal stabilizing agent and the acid gas treating agent can be injected into the emissions stream separately or in combination at one or more injection locations.

The present invention is further summarized in that the acid gas treated can be selected from the group consisting of hydrochloric acid, hydrofluoric acid, sulfur dioxide, and sulfur trioxide.

The present invention is still further summarized in that the hazardous metals treated can be RCRA (United States Resource Conservation and Recovery Act) metals and can be selected from the group consisting of Ba, Cd, Cr, Pb, Hg, Se, Ag, and Zn.

Various tests are used in the art to determine whether leaching potential of a hazardous metal is reduced to a level acceptable to meet to a particular governmental standard. These tests include TCLP, SPLP (Synthetic Precipitation Leaching Procedure), ASTM water leach, California WET (Wet Extraction Test), US EPA MEP (Multiple Extraction Test). Although the methods of the invention can reduce leaching potential of metals to levels acceptable under various regulatory frameworks, such compliance is not a required aspect of the invention.

Likewise, various standards, such as the MACT standards for emission control, can be used to determine the extent of acid gas removal. Although the methods of the invention can remove acid gas to a level acceptable under the MACT standard, removal to such an extent is not a required aspect of the invention.

The present invention is yet further summarized in that a reactive alkaline oxide powder suited for use in the invention is preferably magnesium oxide. Still more preferably, the magnesium oxide is obtained from seawater in a conventional process and is not obtained from calcined magnesite. Brine-derived magnesium oxide is commercially available from American Minerals, Inc. and other suppliers.

Appropriate metal treating chemistry in the context of a flue emissions stream from a high-temperature industrial process is known and conventional metal treatment methods can be used in the method of the invention. Briefly, and by way of non-limiting example, the metal treating agent can itself comprise a plurality of components including agents for pH control, for ORP (Oxidation-Reduction Potential) control, for metal complexation, and for adsorption-co-precipitation. Suitable pH control agents can include MgO, Mg(OH)₂, dolomitic lime, limestone, and other known agents. The metal complexation and adsorption-co-precipitation agents can include phosphates, sulfides, iron and aluminum compounds and chlorides, including phosphoric acid salts of sodium calcium, magnesium, and ammonia; hemametaphosphates and other polyphosphates; sulfides of sodium, calcium, and iron; sulfuric acid salts of iron (both ferrous and ferric) and aluminum; and chlorides of sodium, calcium, magnesium, and aluminum. The exact nature of the metal treating agent can vary with the type and speciation of the metals to be stabilized. A preferred metal treating agent can comprise triple superphosphate and magnesium oxide, which is available as Enviro-blend from American Minerals. For use in the invention, the Enviro-blend particles can be sized so that the magnesium oxide particles have the desired surface area.

The present invention is further summarized in that a method of the invention employing the aforementioned agents is practiced at a temperature below about 350° F., and preferably below 250° F., which is compatible with conventional fabric filter dust collectors of foundry baghouse operations, whereas prior dry treatment methods were operable only at much higher temperatures. Still more preferably, the method of the invention is practiced at a temperature in the range of about 180° F. to about 250 ° F. At a temperature below 350° F., the reactive alkaline oxide powder removes acid gas more effectively than other conventional dry acid gas removal agents such as NaHCO₃, CaO and the like. Despite the relatively higher cost of alkaline oxides over conventional agents, the processes of the invention are more cost effective overall because (1) alkaline oxides can operate in the acid gas removal and metal stabilization aspects of the process, whereas agents such as lime are less effective at both aspects and (2) alkaline oxides having the aforementioned surface area are particularly effective acid gas removers at lower temperatures than those at which conventional systems can operate.

In a related aspect, the temperature of the stream is cooled to a suitable temperature by conventional methods which can include contacting the stream with a controlled water spray, either alone or in combination with dilution air. Alternatively, the stream can be cooled by indirect heat exchange with a cooling media incorporating a heat recovery system. Preferably, after any initial cooling, a final addition of dilution air cools the stream to a temperature suitable for the aforementioned treatments. Optionally, the dilution air of the final addition can comprise a reactive alkaline oxide of the invention, a conventional dry acid gas removal agent, or both, to treat the acid gas in the stream during the final cooling. In the latter case, the conventional agent scrubs the acid gas at temperatures above 350° F., while the reactive alkaline oxide is effective at lower temperatures.

In another related aspect, it is noted that at a cooling temperature below about 250° F., the acid gas can drop below its dew point thereby raising concerns associated with corrosive condensation in emissions stream ducts. To avoid these concerns, a preferred two-step cooling process includes direct water contact cooling to a temperature 30°-50° above the equilibrium dew point of the gas followed by cooling with dilution air comprising a reactive alkaline oxide dessicant in an amount sufficient to lower the saturation humidity of the stream so that the dew point is reduced. The reactive alkaline oxide absorbs condensed water from the stream and at the same time neutralizes acid gas, so that acidic water cannot condense on surfaces of the ducts.

It is an advantage of the present invention that the process is efficient and cost-effective.

It is another advantage of the present invention that the process temperatures are compatible with adding further reaction components such as activated carbon powder for treating mercury, or an oxidizing agent for treating organics such as dioxins and furans.

Other objects, advantages and features will become apparent upon consideration of the following detailed description.

### BRIEF DESCRIPTION OF THE SEVERAL VIEWS OF THE DRAWINGS

Not applicable.

### DETAILED DESCRIPTION OF THE INVENTION

This invention describes an efficient, cost-effective process for simultaneously removing acid gas from, and stabilizing a metal that contaminates particulate matter in, a flue emissions stream from a high-temperature industrial operation, wherein the process comprises the steps of cooling the emissions stream to temperatures below about 350° F., dry injecting a highly reactive MgO powder to remove the acid gas, and dry injecting appropriate treatment agents for reducing the leaching potential of the metals under natural or induced leaching conditions. The broad principles of the invention are described in the context of a generic high-temperature industrial process rather than a specific foundry, smelting, or municipal or industrial solid waste or medical waster incinerator operation to which the invention is likewise applicable.

A flue emissions stream containing an acid gas and particulates contaminated with a hazardous metal is cooled to a temperature below about 350° F. Into the stream are dry injected a metal stabilizing agent in an amount sufficient to reduce leaching potential of the metal under natural or induced leaching conditions and an acid gas treating agent that comprises a reactive alkaline oxide powder, preferably magnesium oxide, having a surface area of at least about 35 m²/g (when measured by BET) (preferably −400 mesh or smaller) in an amount sufficient to neutralize the acid gas and to act as a pH control agent for the metal stabilizing aspect of the invention. A sufficient amount of the alkaline oxide powder can be at least one order of magnitude more than the stoichiometric amount required to neutralize the acid gas, the excess acting as a pH control agent.

The oxide can be fed into the air stream as a slug or continuously. Slug fed means that the oxide is fed into the air stream at a rate that prevents substantial “fall-out” (loss) of the oxide in the ducts so it is carried into the baghouse and is deposited on the bags.

After treatment, the stream is delivered to a separation zone. Particulates are collected in a conventional mechanical or electromechanical collection device such as a baghouse, a cyclone, an electrostatic precipitator, a granular bed filter, a panel bed filter, or an apitron (hybrid fabric filter and electrostatic device), or the like. The particles can contain products of the acid scrub, such as magnesium sulfites and sulfates, unreacted additive, and fly ash, if any. The dry particulates can be pneumatically or mechanically conveyed and removed to a waste disposal area, where they can be wetted or otherwise treated to prevent wind dispersion.

After the bags have operated in the flue gas scrubbing portion of the cycle, the bags are cycled to a shakedown (or bag cleaning) mode. This involved removing the cake of spent alkaline oxide and reaction products from the bag, e.g., by mechanically shaking the bags so the cake falls down into a hopper. Another method of cleaning involves use of jets of high pressure air disposed on the clean side of the bags which blows the cake or dust off the exterior of the bag surface.

### EXAMPLE

Laboratory bench-scale treatability tests were carried out with simulated acid gases containing SO₂ or HCl, wherein the acid gas was passed through a fixed-bed reactor containing the dry acid gas treatment additive. The results of testing carried out at different temperatures are presented below. The BET surface area of the various MgO tested were as follows:

| | |
|---|---|
| MgO (Product A) | 15.6 m²/g |
| MgO (Product B) | 35.0 m²/g |
| Reactive MgO (Product C) | 65.0 m²/g |
| Reactive MgO (Product D) | 150.0 m²/g |

| | | | ACID GAS | |
|---|---|---|---|---|
| ACID | | | CONCEN- | |
| GAS | TEMP | | TRATION | % |
| TYPE | (° F.) | ADDITIVE | (PPM) | REMOVAL |
| HCl | 250° F. | None | 80 | — |
| | | MgO (Product A) | 55.2 | 31.0 |
| | | MgO (Product B) | 43.9 | 45.1 |
| | | Mg(OH)2 | 41.5 | 48.1 |
| | | CaO | 58.7 | 26.6 |
| | | NaHCO₃ | 32.6 | 59.3 |
| | | Reactive MgO (Product | 9.4 | 88.3 |
| | | C) | | |
| | | Reactive MgO (Product | 7.5 | 90.6 |
| | | D) | | |
| SO₂ | 350° F. | None | 11.5 | — |
| | | Reactive MgO (Product | 2.9 | 97.5 |
| | | C) | | |
| | | Reactive MgO (Product | 1.5 | 98.7 |
| | | C) and NaHCO₃ | | |

We claim:

1. A method for treating a flue emissions stream from a high-temperature industrial process in which the stream comprises an acid gas having a dew point and particulates contaminated with a hazardous metal, the method comprising the steps of:
dry injecting into the stream a metal stabilizing agent in an amount sufficient to reduce leaching potential of the metal and an acid gas treating agent that comprises a reactive alkaline oxide powder having a surface area of at least about 35 m²/g in an amount sufficient to remove acid gas and to act as a pH control agent for the metal stabilizing aspect of the invention,
wherein the dry injecting step is performed at a temperature below about 350° F.

2. A method as claimed in claim 1 wherein the dry injecting step is performed at a temperature below the dew point of the acid gas.

3. A method as claimed in claim 2 further comprising the steps of:
cooling the stream to a temperature above the dew point of the acid gas; and
adding a dilution gas that comprises the reactive metal oxide powder to further cool the stream to below the acid gas dew point while dessicating and removing acid gas from the emissions stream.

4. A method as claimed in claim 1 wherein the dry injecting step is performed at a temperature below about 250° F.

5. A method as claimed in claim 1 wherein the dry injecting step is performed at a temperature between about 180° F. and about 250° F.

6. A method as claimed in claim 1 wherein the metal stabilizing agent comprises triple superphosphate.

7. A method as claimed in claim 1 wherein the alkaline oxide is magnesium oxide.

8. A method as claimed in claim 5 wherein the magnesium oxide has a surface area of at least 65 m²/g.

9. A method as claimed in claim 5 wherein the magnesium oxide has a surface area of at least 150 m²/g.

10. A method as claimed in claim 1 wherein the method comprises a single dry injection comprising magnesium oxide and triple superphosphate.
